(19) United States
(12) Patent Application Publication
(10) Pub. No.: US 2024/0369896 A1
(43) Pub. Date: Nov. 7, 2024

(54) PHOTONIC CHIP PROVIDED WITH ONE OR TWO MACH-ZEHNDER MODULATORS

(71) Applicant: Scintil Photonics, Grenoble Cedex 9 (FR)

(72) Inventor: Sylvie Menezo, Grenoble Cedex 9 (FR)

(21) Appl. No.: 18/684,977

(22) PCT Filed: Jul. 18, 2022
(86) PCT No.: PCT/FR2022/051427

§ 371 Date: Feb. 20, 2024

(30) Foreign Application Priority Data
Aug. 31, 2021 (FR) FR2109069

(51) Int. Cl. G02F 1/21; G02F 1/025

(52) U.S. Cl. CPC G02F 1/212; G02F 1/025; G02F 2203/20

(57) ABSTRACT

A photonic chip includes:—a waveguide layer;—one or two Mach-Zehnder modulators formed on and/or in the waveguide layer, comprising a first branch and a second branch, the branches being arranged between an optical input and an optical output in such a way that a light ray injected at the optical input is divided into a first ray and a second ray, which are then recombined at the optical output, each modulation branch being configured to modulate the phase of a light ray. The photonic chip further comprises at least two semiconductor optical amplifiers that are arranged so as to separately amplify the first ray and the second ray before they are recombined at the optical output.

### CROSS REFERENCE TO RELATED APPLICATIONS

This application is a national phase entry under 35 U.S.C. § 371 of International Patent Application PCT/FR2022/051427, filed Jul. 18, 2022, designating the United States of America and published as International Patent Publication WO 2023/031530 A1 on Mar. 9, 2023, which claims the benefit under Article 8 of the Patent Cooperation Treaty to French Patent Application Serial No. FR2109069, filed Aug. 31, 2021.

### TECHNICAL FIELD

The present disclosure relates to the field of photonics and more particularly integrated photonic chips.

In particular, the present disclosure relates to a photonic chip provided with a Mach-Zehnder modulator and for which the insertion losses are compensated by two semiconductor optical amplifiers.

According to the present disclosure, the semiconductor optical amplifiers are arranged to limit the negative effects relative to the amplification of an intensity modulated optical signal.

### BACKGROUND

FIG. 1 shows a Mach-Zehnder device 1 of the prior art. The Mach-Zehnder device 1, in particular, comprises two modulation branches, called first branch 2 and second branch 3, connected at one of their ends by an optical input 4 and at the other of their ends by an optical output 5.

In particular, the two modulation branches 2 and 3 are arranged so that a light ray injected at the optical input 4 is divided into a first ray and a guided second ray, respectively, by the first branch 2 and the second branch 3, and so that the first ray and the second ray are recombined at the optical output.

The device is also provided with two phase modulators, called first modulator 6 and second modulator 7 intended to impose a phase shift, respectively, on the first ray and on the second ray before they are recombined at the optical output 5. The modification of the phase of one and/or the other of the first and the second ray, in particular, makes it possible to modulate the intensity of the recombined ray at the output of the Mach-Zehnder device 1.

However, such a Mach-Zehnder device 1 is subject to losses, and more particularly to losses related to the losses of the phase modulators 6 and 7, which reduce the performance thereof.

Also, in order to overcome this problem, it has been considered to add to the Mach-Zehnder device a semiconductor optical amplifier (or “SOA”) in order to amplify the recombined ray. In this respect, the document [1] cited at the end of the description discloses a Mach-Zehnder device provided with a semiconductor optical amplifier arranged downstream of the optical output 5 of the device.

However, this arrangement is not satisfactory. This is because, as indicated in the document [2] cited at the end of the description, the optical gain G of a semiconductor optical amplifier is not linear. More particularly, the optical gain G decreases when the optical power injected at the input of the amplifier increases, so that the power delivered at the output of the semiconductor optical amplifier cannot exceed a saturation power. This non-linear behavior thus gives rise to distortions of the intensity-modulated signal amplified by the SOA. Moreover, by the “amplitude/phase” coupling effect known to and quantified by the person skilled in the art by the “Henry factor” in III-V semiconductor SOAs or laser components, large optical intensity variations give rise to phase variations, and consequently also alter an intensity-and phase-modulated signal, by also distorting the phase modulation.

Thus, one aim of the present disclosure is to propose a photonic chip provided with at least one Mach-Zehnder modulator whose optical signal can be amplified without imposing a distortion of the modulated signal.

### BRIEF SUMMARY

The aim of the present disclosure is achieved by a photonic chip comprising:
a substrate having a front face;
a waveguide layer disposed on the front face;
one or two Mach-Zehnder modulators formed on and/or in the waveguide layer, each comprising two modulation branches, called first branch and second branch, the modulation branches being arranged between an optical input and an optical output, so that a light ray injected at the optical input is divided into a first ray and a second ray intended to be guided by the Mach-Zehnder modulators, and are then recombined at the optical output, each modulation branch being configured to modulate the phase of a light ray that the modulation branch is capable of guiding;
the photonic chip further comprising at least two semiconductor optical amplifiers arranged to separately amplify the first ray and the second ray before they are recombined at the optical output.

According to one embodiment, each of the two modulation branches comprises a modulation section formed by a waveguide, called a modulation waveguide, and a modulation element, advantageously the modulation element comprises at least one electrode, the modulation element being configured to modulate the phase of a ray capable of being guided by the modulation waveguide, the second branch also comprising a phase shift module configured to impose a fixed phase shift to a light ray capable of being guided by the second branch.

According to one embodiment, the Mach-Zehnder modulator(s) comprises a single Mach-Zehnder modulator, the first branch and the second branch of the single Mach-Zehnder modulator being connected, at one of their ends, by the optical input and, at the other of their ends, by the optical output, so that the first ray and the second ray are guided, respectively, by the first branch and by the second branch.

According to one embodiment, the at least two semiconductor optical amplifiers comprise a first amplifier and a second amplifier arranged, respectively, on the first branch and on the second branch, the first amplifier and the second amplifier being configured to amplify, respectively, the first ray and the second ray.

According to one embodiment, the semiconductor amplifier of a modulation branch is arranged downstream of the modulation section of the modulation branch in question.

According to one embodiment, the semiconductor amplifier of a modulation branch is arranged upstream of the modulation section of the modulation branch in question.

According to one embodiment, the Mach-Zehnder modulator(s) comprises two Mach-Zehnder modulators, respectively, modulator I and modulator Q so that the photonic chip forms an IQ modulator, the first branch and the second branch of the modulator I being connected, at one of their ends, by an intermediate optical input called input I, and, at the other of their ends, by an intermediate optical output called the output I, the first branch and the second branch of the modulator Q being connected, at one of their ends, to another intermediate optical input called input Q, and, at the other of their ends, to another intermediate optical output called output Q.

According to one embodiment, the photonic chip comprises a beam splitter and a ray combiner, the beam splitter comprising two waveguides called, respectively, input guide I and input guide Q, the input guide I and the input guide Q connecting the optical input with, respectively, the input I and the input Q, so that the first ray and the second ray are injected at, respectively, the input I and the input Q, the ray combiner comprising two waveguides called, respectively, output guide I and output guide Q, the output guide I and the output guide Q connecting the optical output with, respectively, the output I and the output Q.

According to one embodiment, the at least two semiconductor optical amplifiers comprise a first amplifier I, a second amplifier I, a first amplifier Q and a second amplifier Q, the first amplifier I and the second amplifier I are respectively arranged on the first branch and on the second branch of the modulator I, while the first amplifier Q and the second amplifier Q are arranged, respectively, on the first branch and on the second branch of the modulator Q.

According to one embodiment, the semiconductor optical amplifier of a modulation branch of a Mach-Zehnder modulator is arranged between the modulation section of the modulation branch in question and the intermediate optical output of the Mach-Zehnder modulator.

According to one embodiment, the semiconductor optical amplifier of a modulation branch of a Mach-Zehnder modulator is arranged between the modulation section of the modulation branch in question and the intermediate optical input of the Mach-Zehnder modulator.

According to one embodiment, the at least two semiconductor optical amplifiers comprise an amplifier I and an amplifier Q carried, respectively, by the output guide I and the output guide Q.

According to one embodiment, the photonic chip further comprises another phase shift module configured to impose another fixed phase shift onto a light ray between the output Q and the optical output.

According to one embodiment, the modulation waveguide comprises silicon, advantageously doped silicon, even more advantageously a PN junction along the silicon waveguide.

According to one embodiment, the at least two semiconductor optical amplifiers comprise a waveguide made of III-V semiconductor materials.

### BRIEF DESCRIPTION OF THE DRAWINGS

Other features and advantages of the present disclosure will emerge from the following detailed description of embodiments of the present disclosure with reference to the appended figures, in which:

FIG. 1 is a schematic representation of a Mach-Zehnder device 1 known from the prior art;

FIG. 2 is a schematic representation of a Mach-Zehnder device capable of being implemented within the scope of the present disclosure;

FIG. 3 is a schematic representation of a support substrate on a face of which the waveguide layer is supported, and along a sectional plane perpendicular to the front face;

FIG. 4 is a schematic representation of a photonic chip according to a first variant of a first embodiment of the present disclosure, the photonic chip according to this first embodiment comprises, in particular, a single Mach-Zehnder modulator and two semiconductor optical amplifiers;

FIG. 5 is a schematic representation of a photonic chip according to a second variant of the first embodiment of the present disclosure, the photonic chip according to this first embodiment comprises, in particular, a single Mach-Zehnder modulator and two semiconductor optical amplifiers;

FIG. 6 is a schematic representation of a photonic chip according to a first variant of a second embodiment of the present disclosure, the photonic chip according to this second embodiment comprises, in particular, two Mach-Zehnder modulators and four semiconductor optical amplifiers;

FIG. 7 is a schematic representation of a photonic chip according to a second variant of a second embodiment of the present disclosure, the photonic chip according to this second embodiment comprises, in particular, two Mach-Zehnder modulators and four semiconductor optical amplifiers;

FIG. 8 shows the photonic chip of FIG. 7 associated with an intermediate module;

FIG. 9 is a schematic representation of a photonic chip according to a third embodiment of the present disclosure, the photonic chip according to this third embodiment, in particular, comprises two Mach-Zehnder modulators and two semiconductor optical amplifiers.

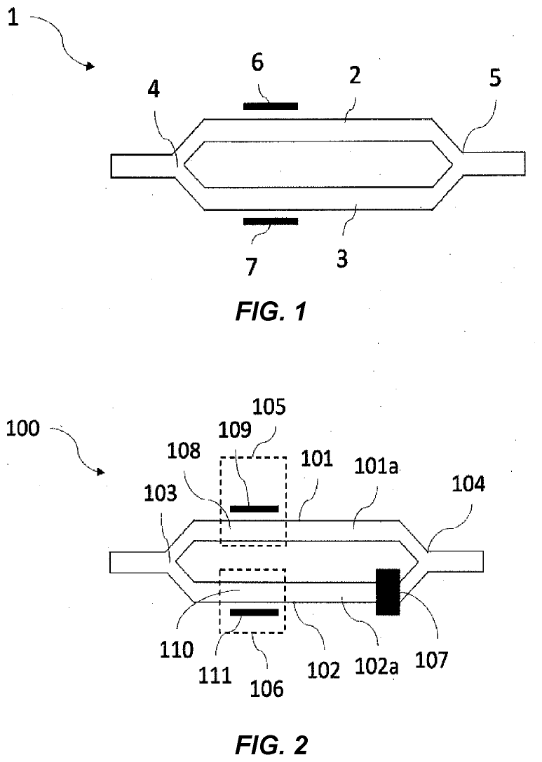

### DETAILED DESCRIPTION

The present disclosure relates to a photonic chip, and more particularly to a photonic chip provided with one or two Mach-Zehnder modulators formed on and/or in a layer, called a waveguide layer, disposed on a front face of a support substrate.

According to the present disclosure, the Mach-Zehnder modulator(s) are arranged between an optical input and an optical output, so that a light ray injected at the optical input is divided into a first ray and a second ray intended to be guided by the Mach-Zehnder modulator(s), and are then recombined at the optical output.

The photonic chip comprises at least two semiconductor optical amplifiers arranged to separately amplify the first ray and the second ray before they are recombined at the optical output.

FIG. 2 is a schematic representation of a Mach-Zehnder modulator 100 capable of being implemented within the scope of the present disclosure.

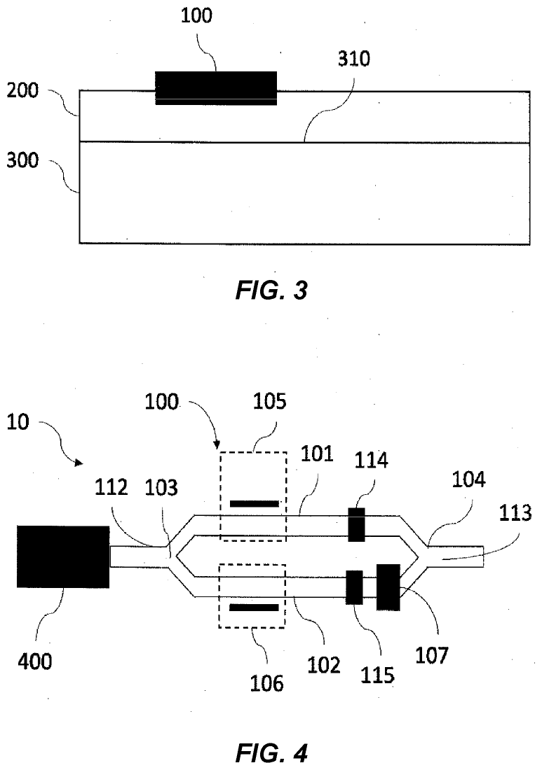

In particular, the Mach-Zehnder modulator 100 can be formed on or in a layer, called a waveguide layer 200 disposed on a front face 310 of a support substrate 300 (FIG. 3).

The support substrate 300 may comprise any type of materials, and more particularly a semiconductor material. In particular, the semiconductor material may comprise silicon, or a III-V semiconductor. Alternatively, the support substrate 300 may comprise a piezoelectric material and, in particular, lithium niobate (LiNbO₃).

The waveguide layer 200 may comprise a dielectric material, for instance, silicon dioxide.

According to the terms of the present disclosure, a Mach-Zehnder modulator comprises two modulation branches, respectively called first branch 101 and second branch 102.

The first branch 101 and the second branch 102 are connected, at one of their ends, by an intermediate optical input 103, and, at the other of their ends, by an intermediate optical output 104.

More particularly, the first branch 101 and the second branch 102 each comprise a waveguide called, respectively, first waveguide 101a and second waveguide 102a. The first branch 101 and the second branch 102 each comprise a modulation section called, respectively, first modulation section 105 and second modulation section 106.

The modulation section of a given modulation branch is configured to modulate the phase of a light ray capable of being guided by the modulation branch in question.

A modulation section of a modulation branch may comprise, in particular, a section of the waveguide of the branch, called the modulation waveguide, and an electrode intended to impose an electrical potential onto the modulation waveguide.

A modulation section is configured, in particular, so that an electrical potential imposed by the electrode on the modulation waveguide modifies the refractive index of the modulation waveguide in question. This index modification makes it possible to impose a phase shift on a light ray likely to be guided by the modulation section in question. In this respect, the modulation waveguide may comprise a doped silicon guide, and more particularly a silicon waveguide accommodating a PN junction. Such a waveguide has a refractive index capable of being modulated as a function of an electrical potential imposed on the waveguide. The document [3] cited at the end of the description provides an example that the person skilled in the art will be able to implement within the scope of the present disclosure. However, the present disclosure is not limited to these aspects alone, and the person skilled in the art could consider other solutions. In particular, and by way of example, the first modulation waveguide 108 and the second modulation waveguide 110 may comprise a III-V semiconductor or even LiNbO₃, for example, transferred by bonding to the substrate.

Thus, the modulation waveguide and the electrode of the first modulation section 105 called, respectively, first modulation waveguide 108 and first electrode 109, make it possible to impose a phase modulation, called first phase shift, onto a light ray guided by the first branch 101. This first phase shift is modulated, in particular, by the electric potential, called first potential, imposed by the first electrode 109.

In an equivalent manner, the modulation waveguide and the electrode of the second modulation section 106 called, respectively, second modulation waveguide 110 and second electrode 111, make it possible to impose a phase modulation, called second phase shift, onto a light ray guided by the second branch 102. This second phase shift is, in particular, modulated by the electric potential, called second potential, imposed by the second electrode 111.

According to the present disclosure, the first potential and the second potential may be equal to, respectively, u(t)/2 and −u(t)/2. In these conditions, the phase shift imposed by the first modulation section 105 and by the second modulation section 106 are equal to, respectively, Mu(t)/2 and −Mu(t)/2 (M is an efficiency factor of a modulator).

The second branch 102 may also comprise a phase shift module 107 configured to impose a fixed phase shift Φ onto a light ray capable of being guided by the second branch 102 that adds to the phase shift −Mu(t)/2.

Thus, a light ray, with intensity Pin, injected at the intermediate optical input 103 is divided into two rays intended to be guided, respectively, by the first branch 101 and the second branch 102. The ray guided by the first branch 101 undergoes a phase shift equal to Mu(t)/2, while the ray guided by the second branch 102 undergoes a phase shift equal to −Mu(t)/2+Φ. These two rays guided, respectively, by the first branch 101 and the second branch 102, are then recombined at the intermediate optical output 104 to form an output ray of intensity Pout.

For a fixed phase shift Φ equal to π/2, Pout follows the following law:

$$Pout = Pin / 2 + Pin / 2 * sin ( M . u ( t ) )$$

It is understood, without it being necessary to specify it, that a branch modulation of a Mach-Zehnder modulator according to the terms of the present disclosure forms an optical path free of branching. In other words, a light ray injected at the intermediate optical input of a Mach-Zehnder modulator only undergoes a single division.

The Mach-Zehnder modulator 100 described above is integrated into a photonic chip 10 that is the subject matter of the present disclosure. More particularly, the photonic chip 10 according to the present disclosure comprises one or two Mach-Zehnder modulators 100 whose modulation branches are arranged between an optical input 112 and an optical output 113 so that a light ray injected at the optical input is split into a first ray and a second ray intended to be guided by the Mach-Zehnder modulators 100, which are then recombined at the optical output.

The photonic chip 10 comprises at least two semiconductor optical amplifiers arranged to separately amplify the first ray and the second ray before they are recombined at the optical output.

FIG. 4 is a schematic representation of a photonic chip 10 according to a first variant of a first embodiment of the present disclosure and implementing a Mach-Zehnder modulator 100 as described above.

In particular, the photonic chip 10, according to this first embodiment, comprises a single Mach-Zehnder modulator 100 and for which the fixed phase shift Φ is equal to π/2. In particular, the optical input 112 and the optical output 113 are conflated, respectively, with the intermediate optical input 103 and the intermediate optical output 104. Thus, a ray injected, for example, by a laser source 400, at the optical input 112 is split into a first ray and a second ray. The first ray is then guided in the first branch 101 to have a phase shift equal to Mu(t)/2 imposed on it. In an equivalent manner, the second ray is guided in the second branch 102 and has a phase shift equal to −Mu(t)/2+π/2 imposed on it.

The photonic chip 10 further comprises two semiconductor optical amplifiers called, respectively, first amplifier 114 and second amplifier 115, which are substantially identical.

The first amplifier 114 is arranged on the first branch 101, while the second amplifier 115 is arranged on the second branch 102. The first amplifier 114 and the second amplifier 115 are thus arranged to amplify, according to a gain G, respectively, the first ray and the second ray.

The integration of a semiconductor optical amplifier with a waveguide is described in the document [1] cited at the end of the description. In particular, such a semiconductor optical amplifier may comprise a quantum multi-well formed from layers of InGaAsP. More particularly, this semiconductor optical amplifier can form a hybrid waveguide coupled with the waveguide of the modulation branch. This coupling may involve a transition section, and, in particular, a tapered waveguide. More particularly, the coupling may be adiabatic as described in the document [4] cited at the end of the description.

Furthermore, a semiconductor optical amplifier can be bonded or formed by epitaxy on a waveguide, and, in particular, a waveguide of silicon.

According to the first variant, the semiconductor optical amplifier of a modulation branch is arranged downstream of the modulation section of the modulation branch in question. In other words, the first amplifier 114 is arranged between the first modulation section 105 and the intermediate optical output 103, while the second amplifier 115 is arranged between the second modulation section 106 and the intermediate optical output 104.

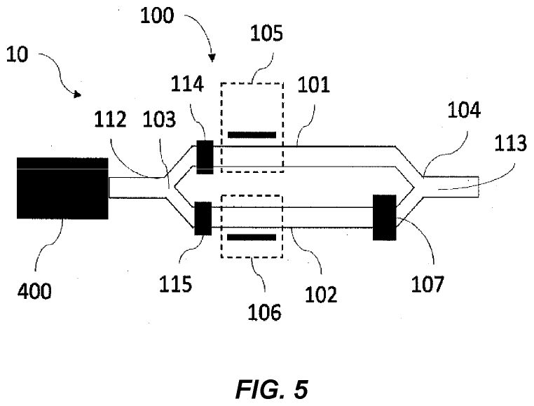

FIG. 5 shows a second variant of the first embodiment of the present disclosure. According to this second variant, the semiconductor optical amplifier of a modulation branch is arranged downstream of the modulation section of the modulation branch in question. In other words, the first amplifier 114 is arranged between the intermediate optical input 103 and the first modulation section 105, while the second amplifier is arranged between the intermediate optical input 103 and the second modulation section 106.

The arrangement of the semiconductor optical amplifiers according to this first embodiment makes it possible to amplify phase-modulated light rays only, not intensity-modulated ones as described in the document [1] cited at the end of the description. In other words, this arrangement makes it possible to limit, or even prevent, the effects of non-linearity of the semiconductor optical amplifiers.

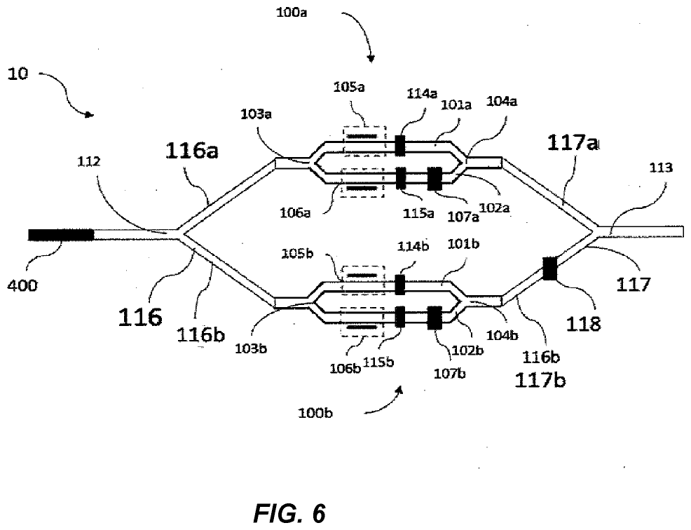

The present disclosure also relates to a second embodiment. To that end, FIG. 6 shows a first variant of the second embodiment.

The photonic chip according to this second embodiment comprises two identical Mach-Zehnder modulators 100, respectively, identical modulator I 100a and modulator Q 100b such that the photonic chip 10 forms an IQ modulator.

The modulator I 100a and the modulator Q 100b essentially adopt the architecture of the Mach-Zehnder modulator 100 of the first variant of the first embodiment.

In particular, the first branch 101 and first waveguide 101a and the second branch 102 and second waveguide 102a of the modulator I 100a are connected, at one of their ends, by the intermediate optical input called the input I 103a, and at the other of their ends, by the intermediate optical output, referred to as the output I 104a. In an equivalent manner, the first branch 101b and the second branch 102b of the modulator Q 100b are connected, at one of their ends, by the intermediate optical input referred to as input “Q” 103b, and at the other of their ends, by the intermediate optical output, called the output Q 104b.

The first waveguide 101a and the second waveguide 102a of the modulator I also comprise, respectively, the first modulation section 105a and second modulation section 106a.

In an equivalent manner, the first branch 101b and the second branch 102b of the modulator Q also comprise, respectively, the first modulation section 105b and second modulation section 106b.

The second waveguide 102a and the second branch 102b each comprise a phase-shift module, called, respectively, module I 107a and module Q 107b. In particular, the module I 107a and the module Q 107b are configured to impose a phase shift Φ equal to I.

The photonic chip 10 further comprises four semiconductor optical amplifiers called first amplifier I 114a, second amplifier I 115a, first amplifier Q 114b and second amplifier Q 115b. In particular, the first amplifier I 114a, the second amplifier I 115a are respectively arranged on the first waveguide 101a and on the second waveguide 102a of the modulator I 100a. In an equivalent manner, the first amplifier Q 114b and the second amplifier Q 115b are arranged, respectively, on the first branch 101b and on the second branch 102b of the modulator Q 100b.

More particularly according to the first variant of the second embodiment, the semiconductor optical amplifier of a modulation branch of a Mach-Zehnder modulator is arranged between the modulation section of the modulation branch in question and the intermediate optical output of the Mach-Zehnder modulator.

Thus, the first amplifier I 114a is arranged between the first modulation section 105a and the output I 104a.

The second amplifier I 115a is arranged between the second modulation section 106a and the output I 104a.

The first amplifier Q 114b is arranged between the first modulation section 105b and the output Q 104b.

The second amplifier Q 115b is arranged between the second modulation section 106b and the output Q 104b.

The photonic chip 10 comprises a beam splitter 116 and a ray combiner 117.

In particular, the beam splitter 116 comprises two waveguides called, respectively, input guide I 116a and input guide Q 116b. The input guide I 116a connects the optical input 112 with the input I 103a, of the modulator I 100a. In an equivalent manner, the input guide Q 116b connects the optical input 112 with the input Q 103b, of the modulator I 100a.

The ray combiner 117 comprising two waveguides called, respectively, output guide I 117a and output guide Q 117b. The output guide I 117a connects the optical output 113 with the output I 104a. The output guide Q 117b connects the optical output 113 with the output Q 104b, of the modulator Q 100b.

The photonic chip may comprise another phase shift module 118 configured to impose another fixed phase shift Φ′ equal to π/2 onto a light ray between the output Q 104b and the optical output 113.

Thus, a light ray injected at the optical input 112, for example, by the laser 400, is split into two rays, called first ray and second ray, respectively injected at the input I and the input Q. The first ray is modulated by the modulator I, to form a first modulated ray, while the second ray is modulated by the modulator Q to form a second modulated ray.

The ray combiner 117 then combines the first modulated ray and the second modulated ray into an output ray.

The arrangement of the semiconductor optical amplifiers according to this first variant of the second embodiment makes it possible to amplify phase-modulated light rays only, not intensity-modulated ones as described in the document [1] cited at the end of the description. In other words, this arrangement makes it possible to limit, or even prevent, the effects of non-linearity of the semiconductor optical amplifiers.

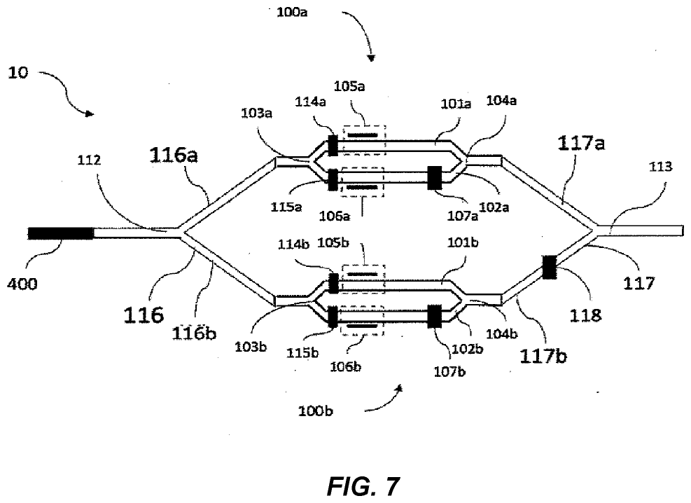

The second embodiment also comprises a second variant shown in FIG. 7, which differs from the first variant in that the semiconductor optical amplifier of a modulation branch of a Mach-Zehnder modulator is arranged between the modulation section of the modulation branch in question and the intermediate optical input of the Mach-Zehnder modulator.

Thus, the first amplifier I 114a is arranged between the input I 103a and the first modulation section 105a.

The second amplifier I 115a is arranged between the input I 103a and the second modulation section 106a.

The first amplifier Q 114b is arranged between the input Q 103b and the first modulation section 105b.

The second amplifier Q 115b is arranged between the input Q 103b and the second modulation section 106b.

The arrangement relative to this second variant is particularly advantageous when the light ray capable of being injected at the optical input 112 has a reduced intensity.

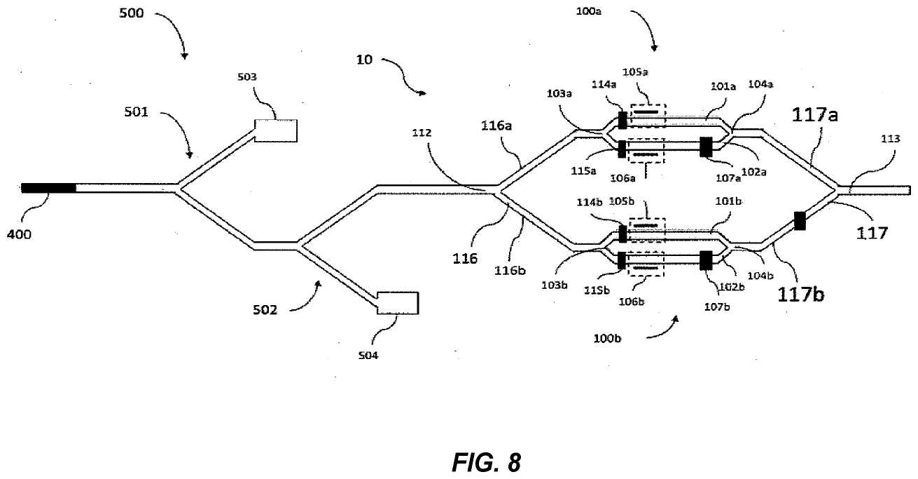

In particular, an intermediate module 500 (FIG. 8) can be interposed between the source 400 and the optical input 112. In particular, the intermediate module 500 comprises a first beam splitter 501, a second beam splitter 502, a local oscillator 503, and a TM modulator 504.

The first beam splitter 501 is configured to split a light ray emitted by the laser into two first intermediate rays. One of these two rays is injected into the local oscillator 503, while the second oscillator receives the other of these first two intermediate rays. The latter is in turn divided by the second beam splitter 502 into two second intermediate rays. One of these two second intermediate rays is injected into the TM modulator 504, while the optical input 112 receives the other of these two second intermediate rays.

According to this configuration, the losses in the beam splitters are significant. The implementation of the four semiconductor optical amplifiers is therefore particularly advantageous.

The arrangement of the semiconductor optical amplifiers according to this second variant of the second embodiment makes it possible to amplify phase-modulated light rays only, not intensity-modulated ones as described in the document [1] cited at the end of the description. In other words, this arrangement makes it possible to limit, or even prevent, the effects of non-linearity of the semiconductor optical amplifiers.

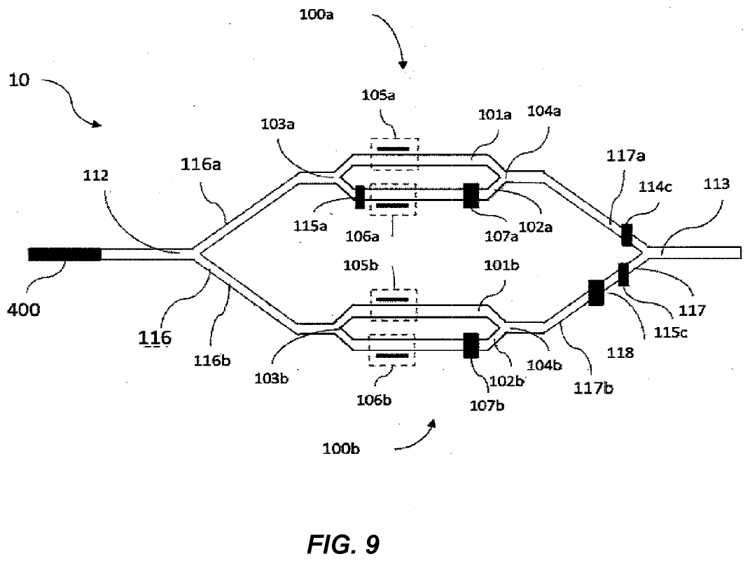

FIG. 9 shows the photonic chip 10 according to a third embodiment of the present disclosure.

This third embodiment differs from the first variant of the second embodiment in that the chip comprises only two semiconductor optical amplifiers called, respectively, amplifier I 114c and an amplifier Q 115c, and carried, respectively, by the output guide I 117a and the output guide Q 117b.

This third embodiment is advantageous when the modulator I and the modulator Q are used only in phase modulators to produce a constellation called “phase shift keying.” According to this configuration, the light rays, at the output I 104a and the output Q 104b, are not intensity-modulated. Each of the two semiconductor optical amplifiers called, respectively, amplifier I 114c and an amplifier Q 115c, and carried, respectively, by the output guide I 117a and the output guide Q 117b, amplify only a phase-modulated ray.

Of course, the present disclosure is not limited to the described embodiments and variant embodiments may be envisaged without departing from the scope of the invention as defined by the claims.

### REFERENCES

[1] T. Hiraki et al., “Membrane InGaAsP Mach-Zehnder Modulator Integrated With Optical Amplifier on Si Platform” J. Lightwave Technol. 38, 3030-3036 (2020);
[2] R. Bonk et al., “Linear semiconductor optical amplifiers for amplification of advanced modulation formats” Opt. Express 20, 9657-9672 (2012);
[3] Reed, G et al., “Silicon optical modulators” Nature Photon 4, 518-526 (2010);
[4] S. Menezo et al., “Back-Side-On-BOX heterogeneous laser integration for fully integrated photonic circuits on silicon” 45^{th} European Conference on Optical Communication (ECOC 2019), 2019, pp. 1-3.

1. A photonic chip, comprising:
a support substrate having a main face;
a waveguide layer disposed on the front face;
two single Mach-Zehnder modulators, respectively, the modulator I and modulator Q such that the photonic chip forms an IQ modulator, the two Mach-Zehnder modulators being formed on and/or in the waveguide layer, each comprising two modulation branches, including a first branch and a second branch arranged between an optical input and an optical output so that a light ray injected at the optical input is split into a first ray and a second ray, intended to be modulated by, respectively, the modulator I and the modulator Q, and are then recombined at the optical output, the two modulation branches of each of the two single Mach-Zehnder modulators comprises a modulation section formed by a modulation waveguide, and a modulation element, the modulation element being configured to modulate the phase of a ray capable of being guided by the modulation waveguide, the second branch further comprising a phase-shift module configured to impose a fixed phase shift onto a light ray capable of being guided by the second branch, the first branch and the second branch of the modulator I being connected, at one of their ends, by an intermediate optical input I, and, at the other of their ends, by an intermediate optical output I, the first branch and the second branch of the modulator Q being connected, at one of their ends, to another intermediate optical input Q, and, at the other of their ends, to another intermediate optical output Q;
a beam splitter and a ray combiner, the beam splitter comprising two waveguides including an input guide I and an input guide Q, the input guide I and the input guide Q connecting the optical input with, respectively, the input I and the input Q, so that the first ray and the second ray are injected at, respectively, the input I and the input Q, the ray combiner comprising two waveguides including an output guide I and an output guide Q, the output guide I and the output guide Q connecting the optical output with, respectively, the output I and the output Q; and
two single semiconductor optical amplifiers including an amplifier I and an amplifier Q carried, respectively, by the output guide I and the output guide Q.

2. The photonic chip of claim 1, further comprising another phase shift module configured to impose another fixed phase shift onto a light ray between the output Q and the optical output.

3. The photonic chip of claim 2, wherein the modulation waveguide comprises silicon.

4. The photonic chip of claim 3, wherein the at least two semiconductor optical amplifiers comprise a waveguide made of III-V semiconductor material.

5. The photonic chip of claim 4, further comprising an intermediate module interposed between a source of a light ray and the optical input, the intermediate module comprising a first beam splitter, a second beam splitter, a local oscillator and a TM modulator.

6. The photonic chip of claim 5, wherein the first beam splitter is configured to divide a light ray, emitted by the source, into two first intermediate rays, one of the two first intermediate rays being injected into the local oscillator while the second beam splitter receives the other of the two first intermediate rays.

7. The photonic chip of claim 6, wherein the second beam splitter is configured to divide the other of the two first intermediate rays into a ray injected into the TM modulator and a ray injected at the optical input.

8. The photonic chip of claim 3, wherein the modulation waveguide comprises doped silicon.

9. The photonic chip of claim 8, wherein the modulation waveguide comprises a PN junction along the waveguide made of silicon.

10. The photonic chip of claim 1, wherein the modulation waveguide comprises silicon.

11. The photonic chip of claim 10, wherein the modulation waveguide comprises doped silicon.

12. The photonic chip of claim 11, wherein the modulation waveguide comprises a PN junction along the waveguide made of silicon.

13. The photonic chip of claim 10, wherein the at least two semiconductor optical amplifiers comprise a waveguide made of III-V semiconductor material.

14. The photonic chip of claim 1, further comprising an intermediate module interposed between a source of a light ray and the optical input, the intermediate module comprising a first beam splitter, a second beam splitter, a local oscillator and a TM modulator.

15. The photonic chip of claim 14, wherein the first beam splitter is configured to divide a light ray, emitted by the source, into two first intermediate rays, one of the two first intermediate rays being injected into the local oscillator while the second beam splitter receives the other of the two first intermediate rays.

16. The photonic chip of claim 15, wherein the second beam splitter is configured to divide the other of the two first intermediate rays into a ray injected into the TM modulator and a ray injected at the optical input.
